(19) United States
(12) Patent Application Publication
(10) Pub. No.: US 2024/0067288 A1
(43) Pub. Date: Feb. 29, 2024

(54) USER AUTHENTICATION AND THEFT DETECTION METHOD FOR TRANSPORTATION MEANS USING SMART HELMET

(71) Applicant: Hyundai Kefico Corporation, Gunpo, Gyeonggi-Do (KR)

(72) Inventor: Sil Lo Jin, Gunpo, Gyeonggi-do (KR)

(21) Appl. No.: 18/270,697

(22) PCT Filed: Dec. 14, 2021
(86) PCT No.: PCT/KR2021/019015

§ 371 Date: Jun. 30, 2023

(30) Foreign Application Priority Data
Dec. 30, 2020 (KR) 10-2020-0187442

(51) Int. Cl. B62H 5/20; G06F 21/32

(52) U.S. Cl. CPC B62H 5/20; G06F 21/32

(57) ABSTRACT

The present invention relates to a method for user authentication and theft detection using a smart helmet, and the smart helmet is equipped with multiple user authentication means, and the motorcycle may transition to the key-on state only when all these authentication means are successfully verified, allowing for the authentication of authorized users for motorcycle operation and preventing theft of the motorcycle. Furthermore, by equipping the smart helmet with a means to detect the user's body temperature and transitioning the motorcycle to the ignition state only when the measured body temperature is above a predetermined temperature, it is possible to restrict the operation of the motorcycle for users who are not wearing the helmet, encouraging users to comply with traffic regulations.

### TECHNICAL FIELD

The present invention relates to a method for user authentication and theft detection using a smart helmet, and more particularly, to a method for authenticating the user and detecting theft using multiple authentication means equipped in a smart helmet for motorcycles, and a method for ensuring compliance with the wearing the smart helmet.

### BACKGROUND ART

Motorcycles, being a type of transportation where the rider's body is directly exposed to the outside, pose a high risk of fatal injuries in the event of an accident, and helmets designed for motorcycles can serve as a safety measure to protect the head in the event of an accident.

However, motorcycles are often used as short-distance means of transportation, involving frequent mounting and dismounting, which leads to frequent instances of removing or not wearing helmets as some riders find it inconvenient and choose to operate motorcycles without wearing them. This ultimately poses a threat to the safety of the rider in the event of an accident, so despite the regulation of helmet usage being stipulated in Article 50, Paragraph 3 of the Korean Road Traffic Act and Article 32 of its enforcement regulations, there may still be limitations to solely relying on legal enforcement, highlighting the need to impose restrictions that render the operation of motorcycles impossible when riders do not possess or wear helmets.

Furthermore, motorcycles, being more susceptible to theft compared to cars, necessitate restrictions on the operation of motorcycles by individuals who are not the rightful owners, as well as the need to issue warnings to the owners in the event of such theft occurrences.

### DISCLOSURE

### Technical Problem

The present invention aims to provide a method for authenticating the owner of a motorcycle or authorized user and preventing the theft of the motorcycle using a multifunctional smart helmet equipped on the motorcycle.

The present invention also aims to provide a method for restricting the operation of a motorcycle when the helmet is not worn, using a multi-functional smart helmet equipped on the motorcycle.

### Technical Solution

In order to accomplish the above objects, the present invention provides a method for user authentication and theft detection of a transportation means controlled by a high-level controller using a smart helmet, the method including a smart helmet authentication step determining whether the smart helmet approaching the transportation means is a registered smart helmet, a user authentication step transitioning the transportation means to a key-on state based on authenticating a holder of the smart helmet being authenticated as a preregistered user of the transportation means via multiple user authentication means equipped on the smart helmet, an ignition authentication step allowing, upon detection of attempting ignition of the transportation means after the user authentication step, ignition based on detecting the authenticated user wearing the smart helmet, and a theft detection step transmitting a theft detection signal to a server based on a number of authentication failures in at least one of the user authentication step and ignition authentication step being equal to or greater than a predetermined number.

Here, the multiple-user authentication means may include at least one of a preregistered user terminal, a fingerprint recognition means, a facial recognition means, and a voice recognition means.

In addition, the user authentication step may include designating an authentication order of the multiple authentication means randomly and transmitting the designated authentication order to a preregistered user terminal to display.

In addition, the user authentication step may include transitioning the transportation means to the key-on state based on the authentication being performed in the designated authentication order.

Here, the smart helmet may include a body temperature measurement means and a facial recognition means.

Meanwhile, the ignition authentication step may include allowing ignition based on an internal temperature of the smart helmet measured using the body temperature measurement means being equal to or greater than a predetermined temperature and a user recognized using the facial recognition means being the preregistered user.

In addition, the theft detection step may include generating and transmitting the theft detection signal to the server based on the number of authentication failures in the user authentication step being equal to or greater than the predetermined number, and the server may transmit the theft detection signal received from the high-level controller to a preregistered user terminal.

In addition, the theft detection step may include generating and transmitting the theft detection signal to the server based on the number of authentication failures in the ignition authentication step being equal to or greater than the predetermined number, and the server may transmit the theft detection signal received from the high-level controller to the preregistered user terminal.

Meanwhile, the method may further include, after the ignition authentication step, an additional authentication step measuring internal temperature of the smart helmet using the body temperature measurement means periodically while the transportation means is in operation, and determining whether a user wearing the smart helmet is the preregistered user using the facial recognition means.

Here, the additional authentication step may include transmitting a helmet wearing alert notification encouraging to wear the smart helmet through the smart helmet based on the measured internal temperature being less than a predetermined temperature.

In addition, the additional authentication step may include controlling the transportation means to be inoperable based on a number of transmissions of the helmet wearing alert notification being greater than a predetermined number.

In addition, the additional authentication step may include generating and transmitting the theft detection signal to the server based on a user worn the smart helmet not being a preregistered user by the facial recognition means, and controlling the transportation means to be inoperable.

Here, the server may transmit the theft detection signal received from the high-level controller to the preregistered user terminal.

### Advantageous Effects

According to the present invention, it is possible to authenticate the authorized user for motorcycle operation and prevent theft of the motorcycle by equipping a smart helmet with multiple user authentication means and transitioning the motorcycle to the key-on state only when all the authentication means are successfully verified.

According to the present invention, it is also possible to restrict the operation of the motorcycle for users not wearing the helmet by equipping the smart helmet with a means to detect the user's body temperature and transitioning the motorcycle to the ignition state only when the measured body temperature is above a predetermined temperature.

### DESCRIPTION OF DRAWINGS

FIG. 1 is a schematic diagram illustrating a smart helmet system implemented with a method for user authentication and theft detection according to an embodiment of the present invention is implemented;

FIG. 2 is an internal block diagram of a high-level controller and a smart helmet within the smart helmet system of FIG. 1;

FIG. 3 is a flowchart illustrating the sequence of a method for user authentication and theft detection according to an embodiment of the present invention; and

FIGS. 4 and 5 are flowcharts illustrating the detailed sequence of an additional authentication step included in the method for user authentication and theft detection of FIG. 3.

### MODE FOR INVENTION

Hereinafter, an embodiment of the present invention will be described in detail with reference to the accompanying drawings.

Given that the invention allows for various modifications and embodiments, specific embodiments will be illustrated in the drawings and described in detail in the specification. However, such modifications and embodiments are not intended to limit the invention and should be construed including all changes, equivalents, and substitutes within the spirit and scope of the invention.

In describing the present invention, terms such as “first,” “second,” and the like may be used to refer to various components, but it should be understood that these terms are not intended to be limiting. The terms are used only for distinguishing one component from another component. For example, a first element may be referred to as a second element and, similarly, the second element may be referred to as the first element, without departing from the scope of the present invention.

The expression “and/or” is used to convey the possibility of including either a combination of multiple related listed items or any one of the related listed items.

When a component is referred to as being “connected to” or “coupled to” another component, it can imply that the two components are directly connected or coupled to each other, but it can also be understood that there may be other components in between them. In contrast, when a component is referred to as being “directly connected to” or “directly coupled to” another component, it can be understood that there is no intermediate component present between them.

The terminology used herein is for the purpose of describing particular embodiments only and is not intended to be limiting of the invention. The singular forms are intended to include the plural forms as well unless the context clearly indicates otherwise.

It will be further understood that the terms “comprises” or “has,” when used in this specification, specify the presence of a stated feature, number, step, operation, component, element, or a combination thereof, but they do not preclude the presence or addition of one or more other features, numbers, steps, operations, components, elements, or combinations thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Furthermore, the following embodiments are provided to explain the invention more fully to those skilled in the art and may involve exaggerated shapes and sizes of components in the drawings for clearer illustration purposes.

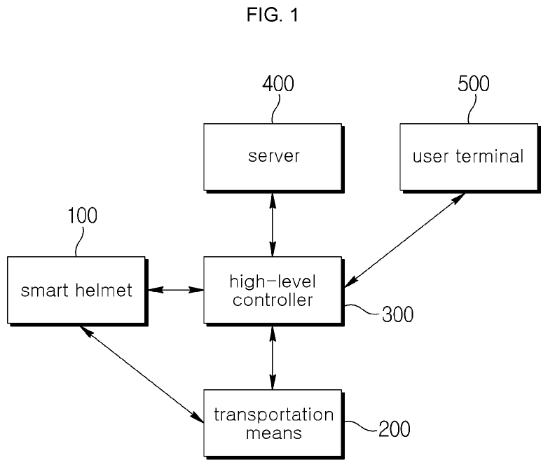

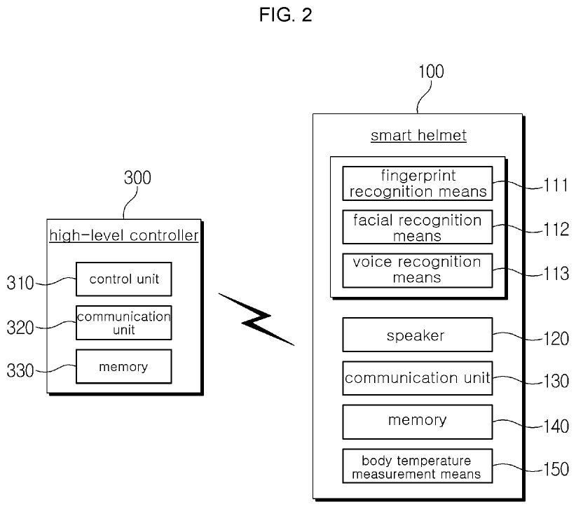

Before proceeding to describe the method for user authentication and theft detection of the present invention, a description of the smart helmet system in which the method for user authentication and theft detection is performed according to an embodiment of the present invention is made with reference to FIGS. 1 and 2.

FIG. 1 is a schematic diagram illustrating a smart helmet system implemented with a method for user authentication and theft detection according to an embodiment of the present invention is implemented, and FIG. 2 is an internal block diagram of a high-level controller and a smart helmet within the smart helmet system of FIG. 1.

With reference to FIG. 1, the smart helmet system may include a smart helmet 100, a transportation means 200, a high-level controller 300, a server 400, and a user terminal 500.

The smart helmet 100 may be equipped with multiple user authentication means to verify whether the holder of the smart helmet 100 is the owner or an authorized user of the transportation means 200 (wherein the transportation means may be an electric two-wheeler).

In this case, the multiple user authentication means may include at least one of a user terminal 500 registered with the high-level controller 300 and/or the transportation means 200, a fingerprint recognition means 111, a facial recognition means 112, and a voice recognition means 113.

Here, the registered user terminal 500 may be a portable device capable of wireless communication with the high-level controller 300 and the server 400, such as a smartphone or a tablet. The registered user terminal 500 may be equipped with a display means capable of displaying various information (authentication sequence of the user authentication means and theft detection signals) transmitted by the high-level controller 300 and the server 400. User authentication using the registered user terminal 500 may be performed through a series of actions by the user, indicated via the display means. The types of actions may include any action that may authenticate the registered user terminal 500, such as entering a password or touching buttons displayed on the display means.

The fingerprint recognition means 111 is a means for authenticating the user by comparing the fingerprint of the holder of the smart helmet 100 with the fingerprint of the user registered in the smart helmet 100 and/or the high-level controller 300, and it may be provided on the outer surface of the smart helmet 100 without any specific limitation on its type or specific operation method. For example, the fingerprint recognition means 111 may be a fingerprint sensor that operates using a sweep method.

The facial recognition means 112 is a means for performing user authentication by comparing the face of the holder of the smart helmet 100 with the user face registered with the smart helmet 100 and/or the high-level controller 300, and it may be provided on the inner side of the smart helmet 100 without any specific limitation on its type or specific operation method. The facial recognition means 112 may be equipped with sensors for recognizing the user's face such as a camera for 2D facial recognition or a light sensor for 3D facial recognition using time-of-flight (ToF) technology.

The voice recognition means 113 serves as a means for user authentication by comparing the voice of the holder of the smart helmet 100 with the user voice registered in the smart helmet 100 and/or the high-level controller 300, and it may be equipped on the outer surface of the smart helmet 100 without any specific limitations on its type or specific operation method. For example, it may be equipped with a microphone and operate in such a way as to receive the voice and convert the voice into an electrical signal and compare the electrical signal with electrical signals of the registered user.

The smart helmet 100 may be equipped with a speaker 120 to emit a helmet-wearing alert when detecting that the user is not wearing the helmet. Additionally, the speaker 120 may also perform the function of emitting a theft alert in case of theft occurrence.

Furthermore, the smart helmet 100 may include a body temperature measurement means 150. The body temperature measurement means 150 serves as a means to detect the wearing status of the helmet and may be equipped on the outer surface of the smart helmet 100 without any specific limitation on its type or specific operation method. For example, the body temperature measurement means 150 may be a non-contact temperature sensor that measures surface temperature using infrared.

Moreover, the smart helmet 100 may include a communication unit 130 for wireless communication and a memory 140.

The communication unit 130 of the smart helmet 100 may include at least one of an infrared (IR) module or an ultrasonic module for infrared or ultrasonic communication, or a short-range communication module such as a Wi-Fi or Bluetooth module. It may also include a wireless Internet module to allow data transmission and reception with external devices (transportation means, high-level controller, etc.) through various wireless technologies such as Wireless LAN (WLAN) or Wireless-Fidelity (Wi-Fi).

The memory 140 of the smart helmet 100 may be a storage medium, such as an electrically erasable programmable read-only memory (EEPROM, non-volatile memory device) and, in this case, the memory 140 of the smart helmet 100 may store information related to the user terminal 500, preregistered user's fingerprints, preregistered user's voice, and preregistered user's face.

The transportation means 200 may be an electric two-wheeler. The transportation means 200 may be an electric two-wheeler capable of transitioning from a power-off state to a key-on state through user authentication. In this case, the key-on state refers to the state where the lock on the handle of the transportation means 200 is released, and the power is turned on for the transportation means 200. However, in this state, the engine does not start, and the operation is restricted until the ignition authentication is performed. The restriction of operation may be achieved, for example, by the high-level controller 300 controlling the supply of power from the battery to the motor. The transportation means 200 may transition to the operational state only after the ignition authentication. The transition to the operational state may be achieved, for example, by the high-level controller 300 controlling the supply of power from the battery to the motor.

The high-level controller 300 may be a control computer that remotely controls the transportation means 200. The high-level controller 300 may include a control unit 310, a communication unit 320, and a memory 330.

The control unit 310 may control the overall functions of user authentication and theft detection using the smart helmet 100 and may also control the operation of the transportation means 200.

The communication unit 320 of the high-level controller 300 may include at least one of an IR (Infrared) module or an ultrasonic module for infrared communication or ultrasonic communication, or a short-range communication module such as a Wi-Fi module or a Bluetooth module. It may also include a wireless Internet module to allow data transmission and reception with external devices (the transportation means, smart helmet, server, user terminal, etc.) through various wireless technologies such as Wireless LAN (WLAN) and Wireless-Fidelity (Wi-Fi).

The memory 330 of the high-level controller 300 may be a recording storage medium such as an electrically erasable programmable read-only memory (EEPROM, non-volatile memory) and, in this case, the memory 330 of the high-level controller 300 may store user terminal information, preregistered user's fingerprint, preregistered user's voice, and preregistered user's face.

The server 400 may be a cloud that may wirelessly communicate with the high-level controller 300, and the server 400 may transmit theft detection a signal received from the high-level controller 300 to the registered user terminal 500.

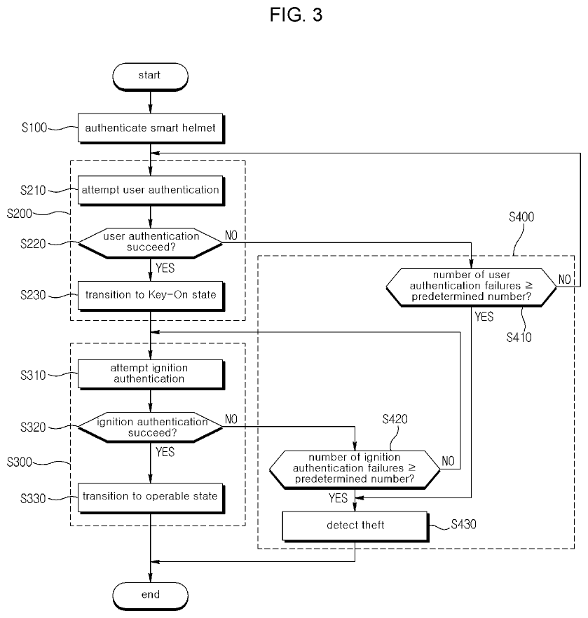

Hereinafter, a description is made of the method of user authentication and theft detection according to an embodiment of the present invention with reference to FIG. 3.

FIG. 3 is a flowchart illustrating the sequence of a method for user authentication and theft detection according to an embodiment of the present invention; and

The method for user authentication and theft detection according to an embodiment of the present invention may be performed by the high-level controller 300 via the smart helmet depicted in FIG. 1.

With reference to FIG. 3, the method for user authentication and theft detection according to an embodiment of the present invention may include authenticating a smart helmet at step S100, authenticating a user at step S200, igniting at step S300, and detecting theft at step S400.

First, when a person wearing a smart helmet approaches the transportation means, smart helmet authentication is performed at step S100 to determine whether the smart helmet is a registered smart helmet 100.

The smart helmet 100 may have preregistered information with the transportation means. For example, the unique information on the smart helmet 100 may be registered in the transportation means 200 using Bluetooth or Bluetooth Low Energy. When the helmet possessed by the user is detected as a registered smart helmet 100 by the transportation means 200, the high-level controller 300 may establish a wireless communication connection with the smart helmet 100 to authenticate the smart helmet 100.

Once the smart helmet 100 is authenticated, user authentication is performed at step S200 to verify whether the holder of the smart helmet 100 is a preregistered user of the transportation means 200. Here, the preregistered user may be the owner of the transportation means 200 or a registered user authorized by the owner.

The verification of whether the holder of the smart helmet 100 is a preregistered user of the transportation means 200 may be done through multiple user authentication means implemented in the smart helmet 100. As described above, these user authentication means may be at least one the registered user terminal 500, fingerprint recognition means 111, facial recognition means 112, and voice recognition means 113.

Hereinafter, a description is made with the exemplary case where the user authentication means include all the four aforementioned authentication means.

In more detail, the high-level controller 300 may randomly designate an authentication order for the four authentication means and transmit the designated authentication order to the registered user terminal to display the designated authentication order. For example, in the case where the authentication order is specified as user terminal authentication, voice recognition authentication, fingerprint recognition authentication, and facial recognition authentication, the registered user terminal 500 may display a message instructing to authenticate in the specified order on the display means, and the user may attempt authentication in that order at step S210. That is, the user terminal authentication may be first conducted with the display means of the user terminal 500 by entering a password or performing a designated button touch and then through voice recognition authentication and fingerprint recognition authentication using the smart helmet 100 and finally facial recognition authentication while wearing the smart helmet 100. When all the multiple authentications are successfully completed (AND condition) in the specified authentication order at step S220, the high-level controller 300 may control the transition of the transportation means 200 to the key-on state at step S230.

After the successful user authentication and transition of the transportation means 200 to the key-on state, the transportation means 200 being in the ignition state, the ignition authentication is performed at step S300.

The ignition authentication step is a process to detect whether the authenticated user is wearing the smart helmet 100, aiming to prevent the operation of the transportation means 200 without wearing the helmet after user authentication.

Specifically, when the user attempts ignition authentication by pressing the ignition button or inserting a key, the high-level controller 300 controls the smart helmet 100 to measure the internal temperature using the temperature measurement means 150 equipped in the smart helmet 100. When the measured internal temperature is equal to or greater than a predetermined temperature, it may be determined that the user is wearing the smart helmet 100. Additionally, the high-level controller 300 may use the facial recognition means 112 equipped in the smart helmet 100 to verify once again at step S310 whether the wearer of the smart helmet 100 is a registered user.

Thus, when it is determined at step S320 that the registered user is wearing the smart helmet 100 using the temperature measurement means 150 and facial recognition means 112, the high-level controller 300 may control the transition of the transportation means 200 to the operable state at step S330, allowing ignition. That is, the operation of the transportation means 200 may only begin when both user authentication is successful and the smart helmet 100 is worn.

On the other hand, when there are a number of authentication failures equal to or greater than a predetermined number in at least one of the user authentication step S200 or the ignition authentication step S300, a theft detection step is performed to send a theft detection signal to the server at step S400.

In more detail, when there are a number of authentication failures equal to or greater than a predetermined number during the user authentication at step S410, the high-level controller 300 generates and transmits a theft detection signal to the server 400 at step S430. In this case, the server 400 may transmit the theft detection signal received from the high-level controller 300 to the registered user terminal 500 to alert the user that the transportation means 200 is currently at risk of theft.

By using multiple authentication means for user authentication and controlling the transition of the transportation means 200 to the key-on state only when all the authentications are successful, the risk of theft for the transportation means 200 may be more effectively prevented.

Furthermore, since the high-level controller 300 randomly assigns the authentication order of the multiple authentication means, each time user authentication is performed and considering it as an authentication failure when the authentication is not conducted according to the designated order, even in the event of the smart helmet 100 being stolen, it becomes impossible to follow the authentication order without the registered user terminal 500, providing further assistance in preventing the risk of theft for the transportation means 200.

Meanwhile, even when there are a number of authentication failures equal to or greater than a predetermined number during the ignition authentication at step S420, the high-level controller 300 also generates and transmits a theft detection signal to the server 400. In this case, the server 400 may transmit the theft detection signal received from the high-level controller 300 to the registered user terminal 500 to alert the user about the risk of theft for the transportation means 200.

This allows for preventing theft risks even when the transportation means 200 is left unattended in the key-on state along with the smart helmet 100 by performing another facial recognition to verify the presence of the registered user before allowing ignition, even when the user authentication is successful.

In addition, the method for user authentication and theft detection according to an embodiment of the present invention may further include performing additional authentication at step S500 while the transportation means 200 is in operation after the ignition authentication step S300.

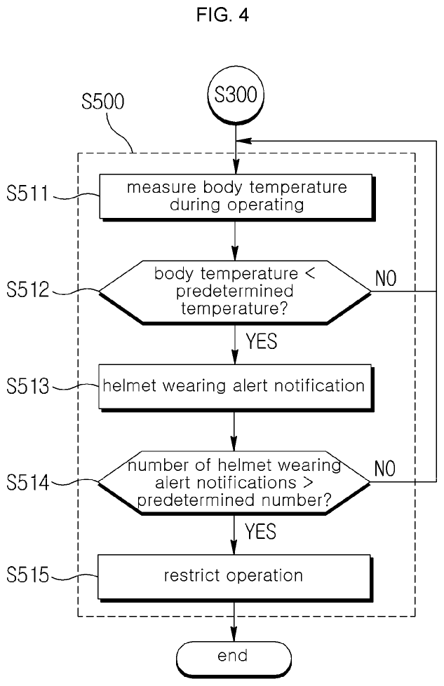

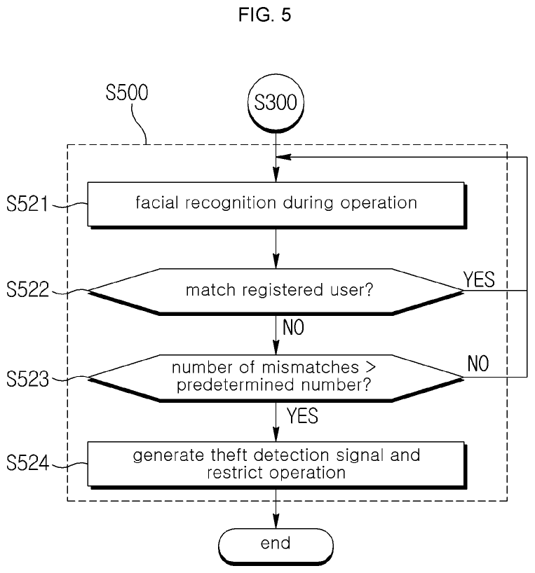

FIGS. 4 and 5 are flowcharts illustrating the detailed sequence of an additional authentication step included in the method for user authentication and theft detection of FIG. 3.

The individual steps S511 to S515 illustrated in FIG. 4 and the individual steps S521 to S524 illustrated in FIG. 5 may be simultaneously performed in parallel during the additional authentication step.

With reference to FIG. 4, the high-level controller 300 may measure the internal temperature of the smart helmet 100 periodically at step S511 using the temperature measurement means 150 equipped in the smart helmet 100 while the transportation means 200 is in operation.

When the measured internal temperature is less than a predetermined temperature at step S512, the high-level controller 300 may transmit a helmet wearing alert notification through the smart helmet 100 at step S513. Here, helmet wearing alert notification may be transmitted using the speaker 120 equipped in the smart helmet 100.

Furthermore, when the number of transmissions of the helmet wearing alert notification exceeds a predetermined number at step S514, the high-level controller 300 may control the transportation means to be inoperable at step S515. For example, the high-level controller 300 may restrict the power supply from the battery of the transportation means 200 to the motor, gradually decelerating the speed of the transportation means 200, and eventually bringing the operation of the transportation means 200 to a complete stop.

By continuously monitoring the wearing of the helmet even during operation, it is possible to prevent users from removing the helmet while driving. Furthermore, by limiting the operation in case of exceeding a predetermined number of alert notifications, it is possible to prevent users from experiencing sudden control failure panic during operation due to temperature detection errors without immediately restricting the operation.

With reference to FIG. 5, the high-level controller 300 may determine at steps S521 and S522 whether the user wearing the smart helmet 100 is a registered user periodically using the facial recognition means 112 equipped in the smart helmet 100 while the transportation means 200 is in operation.

When the user wearing the smart helmet 100 is determined to be a non-registered user for a predetermined number of times or more at step S523, the high-level controller 300 may generate and transmit a theft detection signal to the server and control the operation of the transportation means to be impossible at step S524.

In this case, the server 400 may transmit the theft detection signal received from the high-level controller 300 to the registered user terminal 500.

By continuously verifying whether the wearer of the helmet is a registered user even during operation, it is possible to promptly inform the user of any theft that may occur after the transportation means 200 has been started, facilitating quick and appropriate action to be taken.

As described above, the present invention allows for the authentication of authorized users for motorcycle operation and prevents theft of the motorcycle by equipping a smart helmet with multiple user authentication means and transitioning the motorcycle to the key-on state only when all the authentication means have been successfully verified.

According to the present invention, it is also possible to restrict the operation of the motorcycle for users not wearing the helmet by equipping the smart helmet with a means to detect the user's body temperature and transitioning the motorcycle to the ignition state only when the measured body temperature is above a predetermined temperature, encouraging users to comply with traffic regulations.

Meanwhile, although the present invention has been described with specific embodiments and drawings, the present invention is not limited to the above embodiments, and various modifications and variations can be made from these descriptions by those skilled in the art. Therefore, the technical spirit of the present invention should be determined solely by the claims, and all fair or equivalent modifications thereof would be considered within the scope of the technical concept of the present invention.

1. A method for user authentication and theft detection of a transportation means controlled by a high-level controller using a smart helmet, the method comprising:
a smart helmet authentication step determining whether the smart helmet approaching the transportation means is a registered smart helmet;
a user authentication step transitioning the transportation means to a key-on state based on authenticating a holder of the smart helmet being authenticated as a preregistered user of the transportation means via multiple user authentication means equipped on the smart helmet;
an ignition authentication step allowing, upon detection of attempting ignition of the transportation means after the user authentication step, ignition based on detecting the authenticated user wearing the smart helmet; and
a theft detection step transmitting a theft detection signal to a server based on a number of authentication failures in at least one of the user authentication step and ignition authentication step being equal to or greater than a predetermined number.

2. The method of claim 1, wherein the multiple user authentication means comprises at least one of a preregistered user terminal, a fingerprint recognition means, a facial recognition means, and a voice recognition means.

3. The method of claim 1, wherein the user authentication step comprises designating an authentication order of the multiple authentication means randomly and transmits the designated authentication order to a preregistered user terminal to display.

4. The method of claim 3, wherein the user authentication step comprises transitioning the transportation means to the key-on state based on the authentication being performed in the designated authentication order.

5. The method of claim 1, wherein the smart helmet comprises a body temperature measurement means and a facial recognition means.

6. The method of claim 5, wherein the ignition authentication step comprises allowing ignition based on an internal temperature of the smart helmet measured using the body temperature measurement means being equal to or greater than a predetermined temperature and a user recognized using the facial recognition means being the preregistered user.

7. The method of claim 1, wherein the theft detection step comprises generating and transmitting the theft detection signal to the server based on the number of authentication failures in the user authentication step being equal to or greater than the predetermined number, and the server transmits the theft detection signal received from the high-level controller to a preregistered user terminal.

8. The method of claim 1, wherein the theft detection step comprises generating and transmitting the theft detection signal to the server based on the number of authentication failures in the ignition authentication step being equal to or greater than the predetermined number, and the server transmits the theft detection signal received from the high-level controller to the preregistered user terminal.

9. The method of claim 5, further comprising, after the ignition authentication step, an additional authentication step measuring internal temperature of the smart helmet using the body temperature measurement means periodically while the transportation means is in operation, and determining whether a user wearing the smart helmet is the preregistered user using the facial recognition means.

10. The method of claim 9, wherein the additional authentication step comprises transmitting a helmet wearing alert notification encouraging to wear the smart helmet through the smart helmet based on the measured internal temperature being less than a predetermined temperature.

11. The method of claim 10, wherein the additional authentication step comprises controlling the transportation means to be inoperable based on a number of transmissions of the helmet wearing alert notification being greater than a predetermined number.

12. The method of claim 9, wherein the additional authentication step comprises generating and transmitting the theft detection signal to the server based on a user worn the smart helmet not being the preregistered user by the facial recognition means, and controlling the transportation means to be inoperable.

13. The method of claim 12, wherein the server transmits the theft detection signal received from the high-level controller to the preregistered user terminal.
